(19) United States
(12) Patent Application Publication
(10) Pub. No.: US 2011/0030613 A1
(43) Pub. Date: Feb. 10, 2011

(54) CURTAIN COATER

(75) Inventors: EDUARD DAVYDENKO, Grefrath-Oedt (DE); ANDREAS PESCH, Krefeld (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Andritz Kusters GmbH, Krefeld (DE)

(21) Appl. No.: 12/851,984

(22) Filed: Aug. 6, 2010

(30) Foreign Application Priority Data
Aug. 10, 2009 (DE) 102009036853.1

(51) Int. Cl. B05C 5/00

(52) U.S. Cl. 118/300

(57) ABSTRACT

Curtain coater for discharging coating medium in the form of a curtain moving substantially under the force of gravity onto a moving paper or board web, comprising a hopper, which has a first cavity extending along a discharge width, to which the coating medium is fed via at least one feed line, and a metering channel which discharges the coating medium via an outlet slot as a curtain, wherein the metering channel (2) is broken down into a large number of individual guide channels which, on the inlet side and along the discharge width, adjoin the first cavity (1) with pipe sections (2.1) spaced apart from one another, it being possible for the lengths and opening widths of the pipe sections (2.1) to be chosen in order to even out the flow resistance along the discharge width, and, in the flow direction (S), the pipe sections (2.1) in each case changing into a diffuser (2.2) for the sectional flows from the guide channels to be led together on the outlet side.

### BACKGROUND OF THE INVENTION

The invention relates to a curtain coater for discharging liquid or pasty coating medium in the form of a curtain or film moving substantially under the force of gravity onto a moving substrate, in particular of paper or board.

### BRIEF SUMMARY OF THE INVENTION

It is known from DE 100 57 733 A1 that such a curtain coater comprises a nozzle chamber to which the coating medium is fed via a feed line and which discharges the coating medium through an outlet opening as a curtain or film. In this case, the curtain coater is located at a distance from the substrate, which results in the advantage of non-contact application.

It is difficult to achieve an uniformly thick coating medium curtain across the entire coating width, particularly the greater the coating width is. High web speeds constitute a further high loading on the stability of the coating medium curtain, since the latter is stretched upon contact with the substrate, on account of the difference between the speed shortly before impingement on the substrate and the running speed of the moving substrate. In order to achieve a high-quality coating result, the uniformity of the coating medium curtain with which the latter leaves the outlet opening of the discharge nozzle is therefore of great importance. This applies in particular when the coating medium is intended to be brought onto the substrate substantially in finally metered form, which means that it is a “1:1” coating, and when, in addition, only very small quantities of coating medium are to be applied to the substrate, i.e. a low coat weight.

In order to achieve the most homogeneous possible distribution in the event of a large variation in the volume flows and the material parameters, a distributor system having two cavities, what is known as the side-fed dual cavity die, is additionally known, cf. Stephan F. Kistler, Peter M. Schweizer, Liquid Film Coating, Scientific Principles and their Technological Implications, Chapman & Hall, New York 1997, pages 752 to 767. Following the distribution in a first cavity, the coating compound is led through a first metering slot into a second cavity. The metering slot must produce a high flow resistance. The pressure resulting from this in the first cavity is substantially higher than the transverse pressure loss in the direction of flow. The pressure differences in the flow direction of the first cavity are very low as compared with the total pressure in the first cavity. The pressure distribution and therefore the distribution of the volume flow density over the metering slot are, as a result, approximately uniform in the event of large variations in the volume flows and the material parameters. The remaining deviations are equalized in the second cavity. In order that a high flow resistance is produced, the metering slot must be produced within small dimensions, which lie within the range from 200 to 500 p.m. The volume flow deviations over the outlet width must not exceed a scattering range of 1 to 2%. For this purpose, the flat parts which form the metering slot must be fabricated with a deviation from parallelism in a range from ±1 to 3 μm. The length of the metering slot is normally 20 to 40 mm. The effort for fabrication of flat parts with such dimensions with the required precision, in particular in the case of large coating widths of 10 to 12 metres, is very large and associated with considerable costs.

DE 197 55 625 A1 discloses a curtain coater in which the hopper is composed of two wall-like parts which have a length corresponding to the desired coating width. Machined into one long side of one of the parts is a longitudinal groove which, following the joining of the two parts, forms a cavity. Connected to the cavity is an outlet channel extending over the coating width, from which the coating colour emerges. In order to be able to apply even small quantities of coating colour to paper or board webs of great width under fluctuating conditions, for example fluctuating viscosity or changing coating quantities, uniformly and without problems over the coating width, the flow conditions in the cavity are influenced by the volume flows fed in. For this purpose, at least two feed channels are connected to the cavity, each of which has a device for adjusting the volume flow of coating colour fed in. Tube-pinch or diaphragm valves are preferably used for the volume flow adjustment. The volume flows of each feed channel are therefore adjusted separately. For further evening, a second cavity is arranged between the cavity and the outlet channel. Between the then first cavity and the second cavity there is an additional flow channel. Once more, the requirement for additional actuators for the transverse profile adjustment is disadvantageous. The expenditure in terms of costs associated with this is correspondingly large.

In order to form a curtain, a slot-fed type curtain die or a slide-fed type curtain die can be used. In the case of a slot-fed type curtain die, also called a slot die, of a single-layer curtain coater, the curtain is formed directly at the outlet from the die gap. Curtain coater having a slot die are known, for example, from DE-A1-197 16 647.

The object of the invention is, therefore, to provide a curtain coater which ensures high uniformity of the distribution of a coating medium over an outlet width and, in the process, can be produced cost-effectively.

This object is achieved by the features of claim 1.

In this way, a curtain coater is created which can be operated without any control expenditure. According to the invention, a metering slot is replaced by a large number of guide channels. Each guide channel comprises a pipe section, which is preferably a part having a circular cross section, and a widening of the channel flow which follows in the flow direction, what is known as the diffuser of the guide channel. The guide channels produce a flow resistance approximately equal to that of a metering slot. The fluid mechanics advantages can be seen in the fact that the pipe sections can be matched in terms of length and opening width to a first cavity tapering into the discharge width of the curtain, by which means substantially identical flow resistances are ensured. In this way, evening out of the pressure and/or volume distribution of the coating medium in the transverse direction of the coater is ensured.

The large number of guide channels preferably replace a metering slot between two cavities. The first and second cavity are then arranged one after another in the flow direction and in between these there extends an additional metering slot which, according to the invention, is replaced by a large number of guide channels.

The pipe sections of the guide channels can preferably be produced and inserted in a simple manner as turned parts. Complicated, highly precise flat machine-width or discharge-width parts can be replaced by turned parts.

Further refinements of the invention can be gathered from the following description and the subclaims.

### BRIEF DESCRIPTION OF THE DRAWINGS

The invention will be explained in more detail below by using the exemplary embodiments illustrated in the appended figures, in which:

FIG. 1 shows, schematically, a section of a hopper of a curtain coater in the cross flow direction of the coater according to the prior art,

FIG. 2 shows a cross-sectional view of the hopper according to FIG. 1;

FIG. 3 shows, schematically, a section of a hopper of a curtain coater in the cross flow direction of the coater according to the invention,

FIG. 4 shows, schematically, a cross-sectional view of the hopper according to FIG. 3,

FIG. 5 shows the detail Z according to FIG. 3 in an enlarged illustration,

FIG. 6 shows the detail Y according to FIG. 3 in an enlarged illustration,

FIG. 7 shows the detail W according to A-A according to FIG. 3 in an enlarged illustration,

FIG. 8 shows, schematically, flow lines for a guide channel,

FIG. 9 shows, schematically, a cross-sectional view of the hopper according to a second exemplary embodiment.

### DETAILED DESCRIPTION OF THE INVENTION

The invention relates to a curtain coater for discharging coating medium in the form of a curtain moving substantially under the force of gravity onto a moving paper or board web.

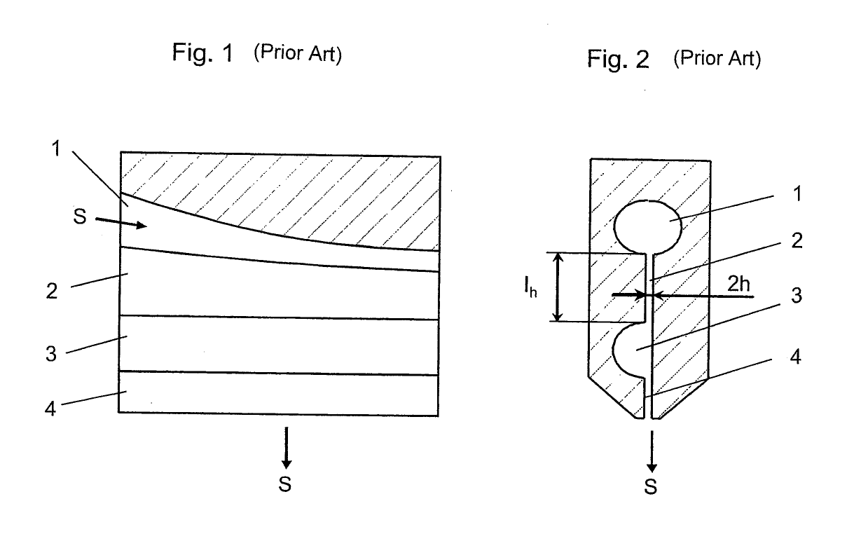

As FIGS. 1 and 2 show, for this purpose the curtain coater according to the prior art comprises a hopper which has a first cavity 1 extending along the discharge width. This cavity 1 is supplied with the coating medium via at least one feed line (not illustrated). The flow direction S of the coating medium to be supplied can originate from one end of the cavity 1, as illustrated in FIG. 1. The hopper further comprises a second cavity 3, which discharges the coating medium via an outlet slot 4 as a curtain. Provided between the first 1 and second cavity 3 is an additional metering channel 2, which is formed as a metering slot. The flow direction S takes place at right angles to the transverse direction of the curtain coater.

The length 1ₕ and the height 2h of the metering channel formed as a metering slot determine a flow resistance which is substantially identical in the transverse direction of the discharge width, since the metering slot is a continuous space. However, the precondition for this is high precision with regard to parallelism of the metering slot walls, in order that the slot height 2h remains constant over the slot length 1ₕ. The problems explained at the beginning in relation to the prior art occur during the fabrication of the hopper, even if the latter is assembled from two halves, as usual.

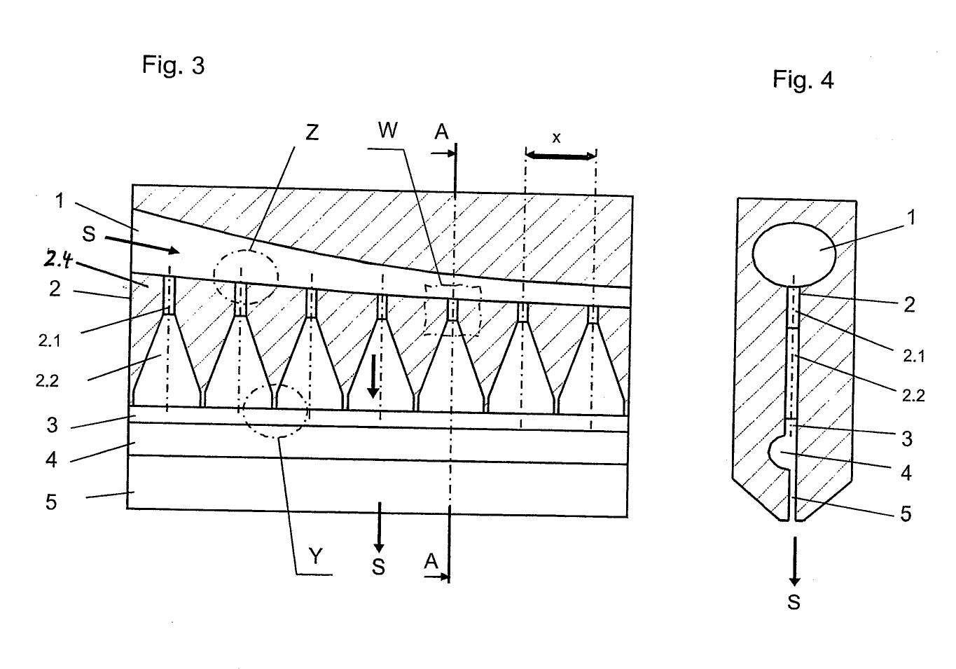

As FIG. 3 and FIG. 4 show, the curtain coater according to the invention in a first exemplary embodiment differs from the prior art in that the additional metering channel 2 is broken down into a large number of individual guide channels which, on the inlet side and along the discharge width, are connected to the first cavity 1 by pipe sections 2.1 spaced apart from one another. The lengths and opening widths of the pipe sections 2.1 can be chosen in order to even out the flow resistance along the discharge width. In the flow direction S, the pipe sections 2.1 each merge into a diffuser 2.2 for the section flows from the guide channels to be combined on the outlet side. Between the ends on the outlet sides of the diffusers 2.2 of the guide channels and the second cavity 4, a remaining part of the height of the metering channel 3 can further be formed in the shape of a machine-width metering slot, in order to combine the individual section flows from the individual guide channels again before the entry into the second cavity 4. The second cavity 4 discharges the application medium via an outlet slot 5 as a curtain. The guide channels are preferably arranged in a base body 2.4 of the hopper.

The guide channels with pipe section 2.1 and diffuser 2.2 extend from the first cavity 1 at right angles to the cross flow direction of the coater, i.e. preferably at right angles to the cross-machine direction (CD) of the moving paper or board web. To this end, the guide channels are preferably arranged in a line.

The flow resistances of the guide channels along the discharge width are substantially equal and are at least 1 mWC (9.81 kPa). The pipe sections 2.1 of the guide channels preferably have a circular cross section. As FIG. 3 shows, the first cavity 4 cannot have an identical length over the discharge width. If the coating medium is supplied from one end, the cavity 1 tapers towards the other discharge end, located opposite this discharge end. Evening out the volume flows is improved here if the lengths 1ᵣ and/or the diameters of the pipe sections 2.1 and/or the distances x between two guide channels in each case are different along the outlet width. As FIG. 3 shows, a shortening of the length 1ᵣ of the pipe sections 2.1 entails a shortening of the length of the first cavity 1. The number of guide channels per metre of the discharge width or outlet width is optional. The number of guide channels preferably lies in the range between 10 and 33. In order to counteract edge flows, it is advantageous to configure the distance x between the guide channels variably over the outlet width.

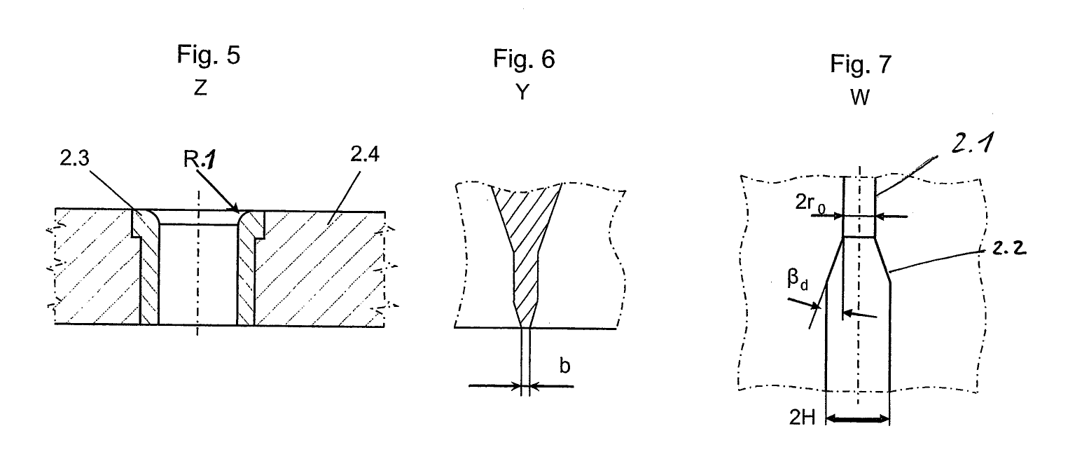

FIGS. 5 to 7 show preferred details of a guide channel according to the invention.

As FIG. 5 shows, the pipe sections 2.1 are preferably formed as replaceable inserts. These inserts can have a chamfer and/or a rounded portion R.1 on their inlet side.

As FIG. 6 shows, in the region of the outlet end, the guide channels have a top width b≦0.3 mm. The guide channels can additionally have outlet ends rounded off at the respective diffuser 2.2. From fluid mechanics points of view, it is advantageous to configure the guide channels in such a way that, in their end region as seen in the flow direction S, they have a blunt end with a top width of less than 0.3 mm or a rounded end, in order to avoid the formation of undesired vortex separations at the end edges.

As FIG. 7 shows, the diffusers 2.2 preferably have a circular cross section on the inlet side in each case, which changes to a rectangular cross section at the outlet. The widening angles β_{d} of the walls of the diffusers 2.2 which bound the flow preferably lie below 8°, in order to avoid reverse flow in the diffuser 2.2. The slot height of the circular pipe section 2.1 of the guide channel is designated 2r₀, and a slot height of the diffuser 2.2 is designated 2H. It is advantageous if the diffuser 2.2 is configured such that a widening of the walls bounding the flow is provided.

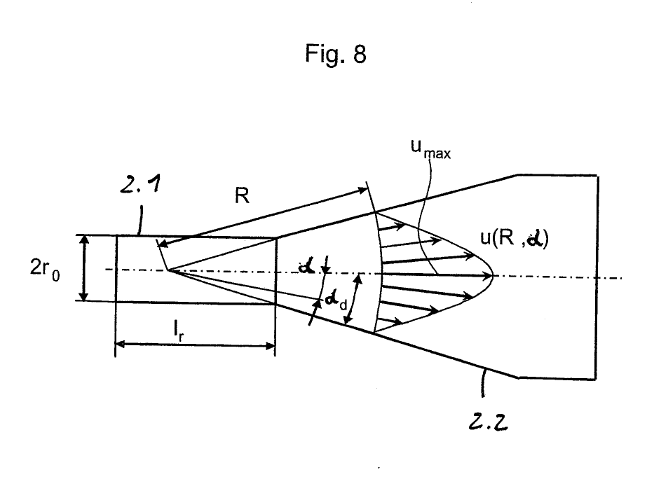

FIG. 8 shows a schematic illustration of the flow relationships in a guide channel with pipe section 2.1 and diffuser 2.2. The opening angle of the diffuser 2.2 is designated by α_{d}. R designates a radial distance. The maximum flow velocity at the distance R is indicated by uₘₐₓ. The diffuser 2.2 is preferably configured such that the velocity distribution of the diffuser flow exhibits high symmetry and reverse flow is avoided. Because of the high viscosity of the coating compound and relatively low velocity, this is a divergent Jeffery-Hamel flow. The angle α_{d} is preferably less than 25°.

The critical widening angle α_{dk} of the walls of the diffuser 2.2 which bound the flow can be determined in accordance with the equation

$$\frac{{α}_{dk}}{tan {α}_{dk}} \cdot \frac{3}{4} \cdot \frac{V 2 {b}_{0} ρ}{μ} < 10.31$$

where μ is the viscosity of the coating medium, ρ is the density of the coating medium, 2b₀=2r₀ and V is the volume flow per metre outlet width.

The parts of the curtain coater touched by the flow are stressed mechanically and chemically. It is therefore advantageous to manufacture the guide channels or the replaceable inserts 2.1 and the basic body 2.4, in which the diffuser 2.2 can be integrated, from stainless steels, such as from the following materials such as molybdenum-free Cr—Ni steels, molybdenum-containing Cr—Ni steels or ferritic-austenitic duplex steels.

Alternatively, the basic body can consist of a thermoplastic. In order to meet high requirements on the inherent stability, chemical resistance, behaviour with respect to moisture (moisture absorption below 1.5%), dimensional stability (low swelling of less than 0.1%), high-performance plastics (amorphous and partially crystalline), such as PEI, PEEK, PPSU, PTFE, PVDF, POM to DIN EN ISO 1043-1, are suitable as a material for the manufacture of the hopper, in particular of the basic body 2.4.

The hopper described in accordance with the invention can be used for curtain coating by the slide-type method or a slot-type method.

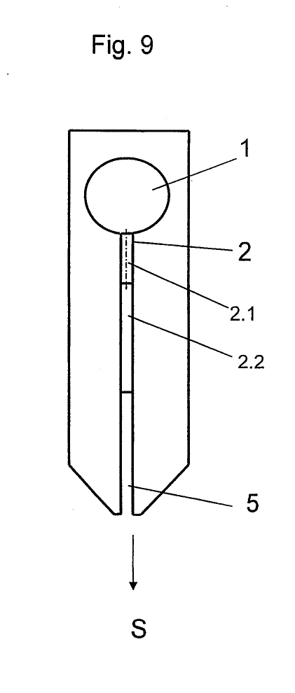

FIG. 9 shows a second exemplary embodiment of the curtain coater for discharging coating medium. Here, the hopper has only a first cavity 1 extending along the discharge width, and a metering channel 2, which discharges the coating medium via the outlet slot 5 as a curtain. The metering channel 2 is broken down into a large number of individual guide channels, as described above in relation to the first exemplary embodiment. The above explanations apply in a corresponding way here.

All publications and patent applications mentioned in this specification are herein incorporated by reference to the same extent as if each individual publication or patent application was specifically and individually indicated to be incorporated by reference.

The invention now being fully described, it will be apparent to one of ordinary skill in the art that many changes and modifications can be made thereto without departing from the spirit or scope of the appended claims.

1. Curtain coater for discharging coating medium in the form of a curtain moving substantially under the force of gravity onto a moving paper or board web, comprising a hopper, which has a first cavity extending along a discharge width, to which the coating medium is fed via at least one feed line, and a metering channel which discharges the coating medium via an outlet slot as a curtain, wherein the metering channel is broken down into a large number of individual guide channels which, on the inlet side and along the discharge width, adjoin the first cavity with pipe sections spaced apart from one another, it being possible for the lengths and opening widths of the pipe sections to be chosen in order to even out the flow resistance along the discharge width, and, in the flow direction, the pipe sections in each case changing into a diffuser for the sectional flows from the guide channels to be led together on the outlet side.

2. Curtain coater according to claim 1, wherein a second cavity is provided, which discharges the coating medium via the outlet slot as a curtain, and the metering channel is arranged between the first cavity and the second cavity.

3. Curtain coater according to claim 1, wherein the guide channels extend from the first cavity at right angles to the cross flow direction of the coater.

4. Curtain coater according to claim 1, wherein the flow resistances of the guide channels along the discharge width are substantially equal and are at least 1 mWC.

5. Curtain coater according to claim 1, wherein the guide channels are arranged in a line.

6. Curtain coater according to claim 1, wherein the pipe sections of the guide channels have a circular cross section.

7. Curtain coater according to claim 1, wherein the widening angle (α_{d}) of the walls of the diffusers that bound the flow lie below 25°.

8. Curtain coater according to claim 1, wherein the widening angle (α_{d}) of the walls of the respective diffuser that bound the flow is chosen as a function of the volume flow, density and dynamic viscosity of the respective coating medium.

9. Curtain coater according to claim 1, wherein the diffusers have a circular cross section on the inlet side in each case, which changes to a rectangular cross section at the outlet.

10. Curtain coater according to claim 1, wherein the lengths and/or the diameters of the pipe sections and/or the distances between the guide channels are different along the outlet width.

11. Curtain coater according to claim 1, wherein the pipe sections are formed as replaceable inserts.

12. Curtain coater according to claim 11, wherein the inserts have a chamfer and/or a rounded portion on their inlet side.

13. Curtain coater according to claim 1, wherein, in the region of the outlet end of the diffuser, the guide channels have a top width≦0.3 mm.

14. Curtain coater according to claim 1, wherein the guide channels have rounded-off outlet ends.

15. Curtain coater according to claim 1, wherein, in the flow direction, a machine-width chamber adjoins the guide channels as a metering slot and, after that, a second cavity.
